(19) United States
(12) Patent Application Publication
(10) Pub. No.: US 2009/0070570 A1
(43) Pub. Date: Mar. 12, 2009

(54) System and Method for Efficiently Handling Interrupts

(76) Inventors: Shubhodeep Roy Choudhury, Bangalore (IN); Manoj Dusanapudi, Bangalore (IN); Sunil Suresh Hatti, Bangalore (IN); Shakti Kapoor, Austin, TX (US); Rahul Sharad Moharil, Nagpur (IN)

Correspondence Address: IBM CORPORATION- AUSTIN (JVL);C/O VAN LEEUWEN & VAN LEEUWEN, PO BOX 90609, AUSTIN, TX, 78709-0609, US

(21) Appl. No.: 11/853,208

(22) Filed: Sep. 11, 2007

(51) Int. Cl. G06F 9/30; G06F 11/263

(52) U.S. Cl. 712/244; 714/34; 712/E09.032; 714/E11.177

(57) ABSTRACT

A system and method for including independent instructions into a test case for intentionally provoking interrupts that may be used in conjunction with an instruction shuffling process is presented. A test case generator builds a test case that includes intentional interrupt instructions, which are constructed to intentionally provoke an interrupt, such as an instruction storage interrupt (ISI), a data storage interrupt (DSI), and alignment interrupt, and/or a program interrupt (PI). When a processor executes the test case and invokes an interrupt to an interrupt handler, the interrupt handler does not resolve the interrupt, but rather increments an instruction address register or a link register and resumes test case execution at an instruction subsequent to the instruction that caused the interrupt.

### BACKGROUND OF THE INVENTION

1. Technical Field

The present invention relates to a system and method for efficiently handling interrupts. More particularly, the present invention relates to a system and method for including independent instructions into a test case for intentionally provoking efficiently handled interrupts that may be used in conjunction with an instruction shuffling process.

2. Description of the Related Art

Processor testing tools exist whose goal is to generate the most stressful test case for a processor. In theory, the generated test case should provide maximum test coverage and should be interesting enough to stress various timing scenarios on the processor. The whole technology of these tools sits in the logic of building these test cases.

Verifying and validating a processor using test cases typically includes three stages, which are 1) test pattern build stage, 2) test pattern execution stage, and 3) validation and verification stage. Testing interrupts requires generating and building the interrupts into a test case in addition to handling the interrupts in an interrupt service routine (interrupt handler). A challenge found is that the interrupt service routine spends a large amount of time handling the interrupt, which increases the overall test case execution time.

In addition, situations arise in which a test case is not able to generate an interrupt in a normal manner. For example, a test case may provoke an instruction storage interrupt (ISI) by scattering a test stream in two pages. However, when using shuffler technology in which instructions are shuffled and moved, invoking an ISI in this manner is difficult and unpredictable.

What is needed, therefore, is a system and method for efficiently handling interrupts in addition to provoking interrupts for use with shuffler technology.

### SUMMARY

It has been discovered that the aforementioned challenges are resolved using a system and method for including independent instructions into a test case for intentionally provoking interrupts that may be used in conjunction with an instruction shuffling process. A test case generator builds a test case that includes intentional interrupt instructions, which are constructed to intentionally provoke an interrupt, such as an instruction storage interrupt (ISI), a data storage interrupt (DSI), an alignment interrupt, and/or a program interrupt (PI). When a processor executes the test case and invokes an interrupt to an interrupt handler, the interrupt handler does not resolve the interrupt, but rather increments an instruction address register or a link register, and resumes test case execution at an instruction subsequent to the instruction that caused the interrupt.

When a test case generator builds an instruction into a test case in order to provoke an instruction storage interrupt (ISI), the test case generator uses an instruction, such as a branch instruction, that branches to a particular target branch address and updates a link register (LR) with the instruction address of the next instruction in the test case. The test case generator, however, does not include a valid instruction address translation for the target branch address in a translation lookaside buffer (TLB). As a result, a processor invokes an instruction storage interrupt to an interrupt handler when it executes the instruction. Instead of resolving the interrupt, the interrupt handler returns to the test case using the link register and resumes test case execution at the instruction location corresponding to the link register. In one embodiment, the processor may also access a page table in an attempt to locate a valid instruction address translation.

In addition, when the test case generator builds an instruction into a test case in order to provoke a data storage interrupt (DSI), the test case generator uses an instruction, such as a load/store instruction, that accesses a memory location for data. The test case generator, however, does not include a valid data address translation for the memory location in the TLB. As a result, the processor invokes a data storage interrupt to the interrupt handler when it executes the instruction. Instead of resolving the interrupt, the interrupt handler increments an instruction address register and resumes test case execution at the instruction location corresponding to the incremented address register. In one embodiment, the processor may also access a page table in an attempt to locate a valid data address translation.

Furthermore, when the test case generator builds an instruction into a test case in order to provoke an alignment interrupt, the test case generator includes an instruction with an unaligned effective address. As a result, the processor invokes an alignment interrupt to the interrupt handler when it executes the instruction. Instead of resolving the interrupt, the interrupt handler increments the instruction address register and resumes test case execution at the instruction location corresponding to the incremented address register.

Finally, when a test case generator builds an instruction into a test case in order to provoke a program interrupt, the test case generator includes an instruction with an invalid operand or opcode. As a result, the processor invokes a program interrupt to the interrupt handler when it executes the instruction. Since a program interrupt also occurs at the end of a test case, the interrupt handler first checks whether the program interrupt resulted from the processor being at the end of the test case. If so, the interrupt handler passes control to a control program. When the program interrupt results from a different location, the interrupt handler increments the instruction address register and resumes test case execution at the instruction location corresponding to the incremented address register.

As can be seen, since the interrupt handler does not spend time resolving the interrupt, overall test time is decreased. In addition, since the intentional interrupt instructions are independent, the instructions may be placed at various locations within a test case during an instruction shuffling process.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings.

FIG. 1 is a diagram showing a test case generator building a test case that includes intentional interrupt instructions that are constructed to intentionally provoke an interrupt;

FIG. 2A is a diagram showing an interrupt service routine processing an instruction storage interrupt (ISI) by incrementing an instruction address counter, and resuming test case execution at the corresponding incremented address;

FIG. 2B is a diagram showing an interrupt service routine processing a data storage interrupt (DSI) by incrementing an instruction address counter and resuming test case execution at the corresponding incremented address;

FIG. 3A is a diagram showing an interrupt service routine processing an alignment interrupt by incrementing an instruction address counter and resuming test case execution at the corresponding incremented address;

FIG. 3B is a diagram showing an interrupt service routine processing a program interrupt by either incrementing an instruction address counter and resuming test case execution at the corresponding incremented address, or returning to a control program;

FIG. 4 is a flowchart showing steps taken in building intentional interrupt instructions into a test case;

FIG. 5 is a diagram showing a broadband element architecture which includes a plurality of heterogeneous processors capable of implementing the invention described herein;

FIG. 6 is a block diagram illustrating a processing element having a main processor and a plurality of secondary processors sharing a system memory; and

FIG. 7 is a block diagram of a computing device capable of implementing the present invention.

### DETAILED DESCRIPTION

The following is intended to provide a detailed description of an example of the invention and should not be taken to be limiting of the invention itself. Rather, any number of variations may fall within the scope of the invention, which is defined in the claims following the description.

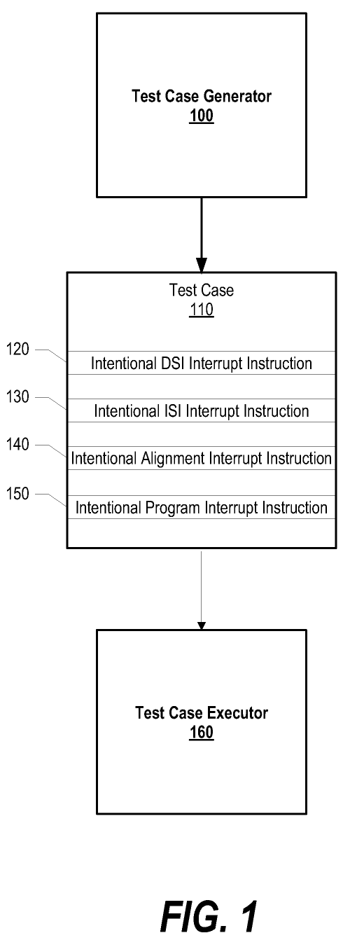

FIG. 1 is a diagram showing a test case generator building a test case that includes intentional interrupt instructions that are constructed to intentionally provoke an interrupt. Test case generator 100 builds test case 110 and provides test case 110 to test case executor 160 for execution. During the test case building process, test case generator 100 includes instructions 120 through 150 that are constructed to intentionally generate an interrupt, such as an instruction storage interrupt (ISI), a data storage interrupt (DSI), and alignment interrupt, and/or a program interrupt (PI). An interrupt handler does not resolve the interrupts, but rather increments an instruction address register or a link register and resumes test case execution at an instruction subsequent to the instruction that caused the interrupt.

Each of interrupts 120-150 are independent and, as a result, these instructions may be used in conjunction with an instruction shuffling process. During an instruction shuffling processes, a test case generator generates and provides a test case that includes multiple sub test cases to a test case executor. In turn, the test case executor recursively schedules and dispatches the test case with different shuffled instruction orders to a processor in order to efficiently test the processor. In one embodiment, the test case generator provides multiple test cases to the test case executor. In another embodiment, the test case generator provides test cases to multiple test case executors that, in turn, shuffle the test cases and provide the shuffled test cases to their respective processor.

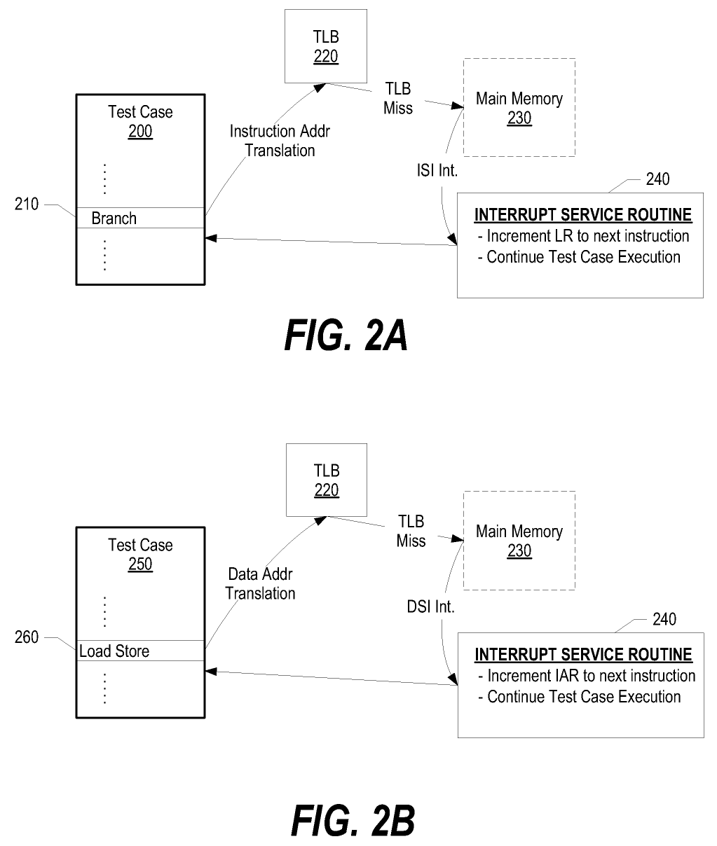

Test case generator 100 constructs intentional ISI interrupt instruction 120 using an instruction, such as a branch instruction, that branches to a target branch address. Test case generator 100, however, does not include a valid instruction address translation for the target branch address in a translation lookaside buffer (TLB). As a result, a processor invokes an instruction storage interrupt (ISI) when it executes instruction 120 (see FIG. 2A and corresponding text for further details).

Test case generator 100 constructs intentional DSI interrupt instruction 130 using an instruction, such as a load/store instruction, that accesses memory to create a fault. Test case generator 100, however, does not include a valid translation to resolve the fault in a translation lookaside buffer (TLB). As a result, the processor invokes a data storage interrupt when it attempts to access the translation (see FIG. 2B and corresponding text for further details).

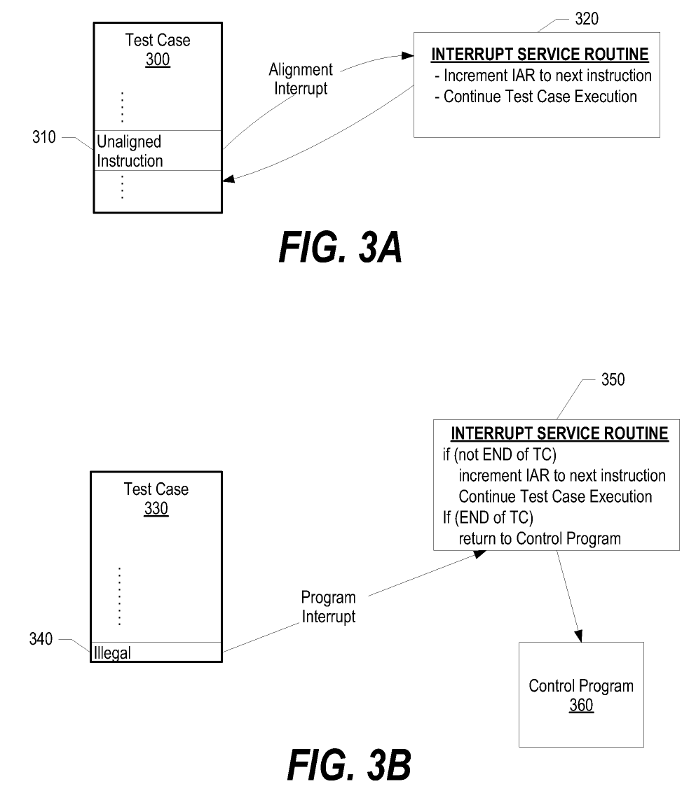

Test case generator 100 constructs intentional alignment interrupt instruction 140 by including an instruction with an unaligned effective/real address, such as a floating point load/store instruction. As a result, the processor invokes an alignment interrupt (see FIG. 3A and corresponding text for further details).

Test case generator 100 constructs intentional program interrupt instruction 150, which is an instruction that includes an invalid operand or opcode. An illegal instruction also marks the end of test case 110. When a processor initiates a program interrupt to an interrupt handler, the interrupt handler checks whether or not the program interrupt results from the end of test case 100 by comparing the faulted address with a last instruction address that is stored in a special register (see FIG. 3B and corresponding text for further details).

FIG. 2A is a diagram showing an interrupt service routine processing an instruction storage interrupt (ISI) by incrementing an instruction address counter, and resuming test case execution at the corresponding incremented address. A processor executes test case 200 that includes branch instruction 210. A test case generator constructs branch instruction 210 to cause an instruction storage interrupt by specifying a particular target branch address without creating a valid instruction address translation for the particular target branch address. This branch is a special type of branch instruction that also updates a LR (link register) with the next instruction in the test case.

When a processor executes test case 200 and reaches instruction 210, the processor checks for the target branch instruction address translation within translation lookaside buffer (TLB) 220. Since a valid instruction address translation was not created, TLB 220 does not include the translation. In turn, the processor may attempt to access a page table located in main memory 230 in order to locate the instruction address translation. In one embodiment, such as a manufacturing environment, main memory 230 may not available. In another embodiment that includes main memory 230, the page table does not include a valid instruction address translation because, as discussed above, the translation was never created.

Since the processor is not able to locate the instruction address translation, the processor initiates an instruction storage interrupt to interrupt service routine 240. Interrupt service routine 240 does not resolve the interrupt, but rather ignores the interrupt, uses the LR register to jump to next test case instruction, and resumes execution of test case 200 at the incremented address after instruction 210. As can be seen, since interrupt service routine 240 does not spend time resolving the interrupt, overall test time is decreased. In addition, since instruction 210 is independent, instruction 210 may be placed at various locations within test case 200 during an instruction shuffling process.

FIG. 2B is a diagram showing an interrupt service routine processing a data storage interrupt (DSI) by incrementing an instruction address counter and resuming test case execution at the corresponding incremented address. A processor executes test case 250 that includes load\store instruction 260. A test case generator constructs load/store instruction 260 to cause a data storage interrupt by specifying a particular data address without creating a valid data address translation for the particular data address.

When a processor executes test case 250 and reaches instruction 260, the processor checks for a data address translation within translation lookaside buffer (TLB) 220. Since a valid data address translation was never created at build time, TLB 220 does not include the translation. In turn, the processor may attempt to access a page table located in main memory 230 to located the data address translation. In one embodiment, such as a manufacturing environment, main memory 230 may not available. In another embodiment that includes main memory 230, the page table does not include the data address translation because, as discussed above, a valid data address translation was never created.

Since the processor is not able to locate the data address translation, the processor initiates a data storage interrupt to ISR 240. Interrupt service routine 240 does not resolve the interrupt, but rather ignores the interrupt, increments an instruction address register (IAR), and resumes execution of test case 200 at the incremented address after instruction 260.

FIG. 3A is a diagram showing an interrupt service routine processing an alignment interrupt by incrementing an instruction address counter and resuming test case execution at the corresponding incremented address. A processor executes test case 300 that includes instruction 310. Instruction 310 is constructed with an unaligned effective address, such as a load Quadword DQ form PowerPC instruction. For example, if EA60:63 is not equal to 0b0000, then the alignment interrupt handler may be invoked.

When a processor executes test case 300 and reaches instruction 310, the processor detects the unaligned effective address and generates an alignment interrupt. In turn, interrupt service routine 320 does not resolve the interrupt, but rather ignores the interrupt, increments an instruction address register (IAR), and resumes execution of test case 300 at the incremented address after instruction 310.

FIG. 3B is a diagram showing an interrupt service routine processing a program interrupt by either incrementing an instruction address counter and resuming test case execution at the corresponding incremented address, or returning to a control program. A processor executes test case 330 that includes instruction 340. Instruction 340 is an illegal instruction that invokes a program interrupt, such as an instruction whose opcode is not defined in the processor instruction set, or an instruction that does not follow an instruction operand definition as provided in the processor instruction set.

When a processor executes test case 330 and reaches instruction 340, the processor generates a program interrupt. In turn, interrupt service routine 350 determines whether the program interrupt occurred at the end of test case 330. As can be seen in FIG. 3B, instruction 340 is at the end of test case 330 and, as a result, ISR 350 returns to control program 360. When instruction 340 is not at the end of a test case, ISR 350 increments an instruction address register and resumes execution of test case 340 at the incremented address after instruction 340 as discussed in FIGS. 2A, 2B, and 3A.

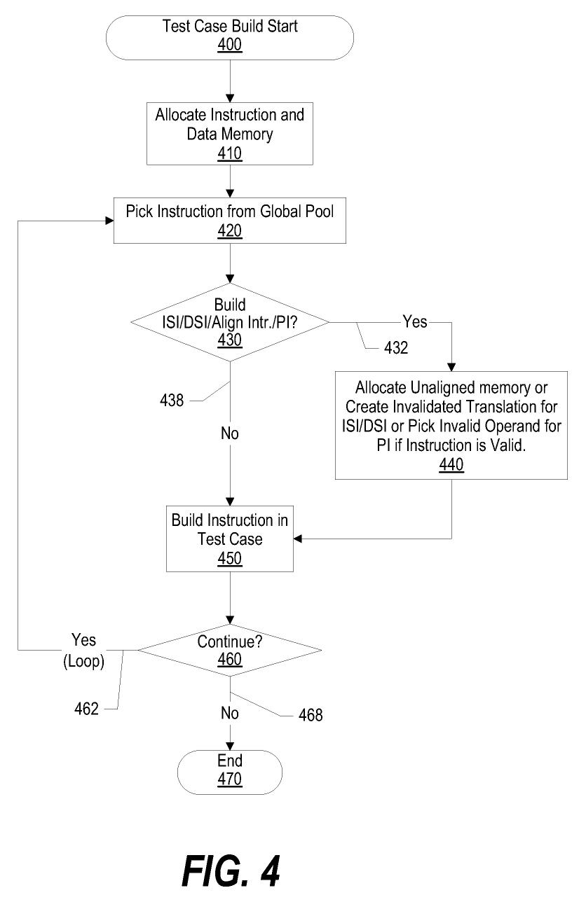

FIG. 4 is a flowchart showing steps taken in building intentional interrupt instructions into a test case. Processing commences at 400, whereupon processing allocates instruction and data memory for the test case. At step 420, processing picks an instruction from a global instruction pool.

A determination is made as to whether to build the instruction in such a manner as to provoke an instruction storage interrupt, a data storage interrupt, an alignment interrupt, or a program interrupt (decision 430). For example, if the picked instruction is a branch instruction, processing may build the branch instruction without an target branch instruction address translation, which provokes an instruction storage interrupt.

If processing should build the instruction in such a manner as to provoke an interrupt, decision 430 branches to “Yes” branch 432, whereupon processing builds the instruction as an intentional interrupt instruction at step 440. For example, to provoke an ISI or DSI, processing creates a corresponding invalid instruction address translation (for a branch instruction) or an invalid data address translation (for a load/store instruction), respectively. In another example, to provoke an alignment interrupt, processing allocates unaligned memory to the instruction. In yet another example, to provoke a program interrupt, processing picks an invalid operand/opcode for the instruction. On the other hand, if processing should not build the instruction in such a manner as to provoke an interrupt, processing branches to “No” branch 438, bypassing intentional interrupt instruction generation steps.

At step 450, processing builds the instruction into the test case (either normally or as an intentional interrupt instruction). A determination is made as to whether to continue building the test case (decision 460). If processing should continue building the test case, decision 460 branches to “Yes” branch 462, which loops back to pick and build another instruction. This looping continues until processing should terminate, at which point decision 460 branches to “No” branch 468 whereupon processing ends at 470.

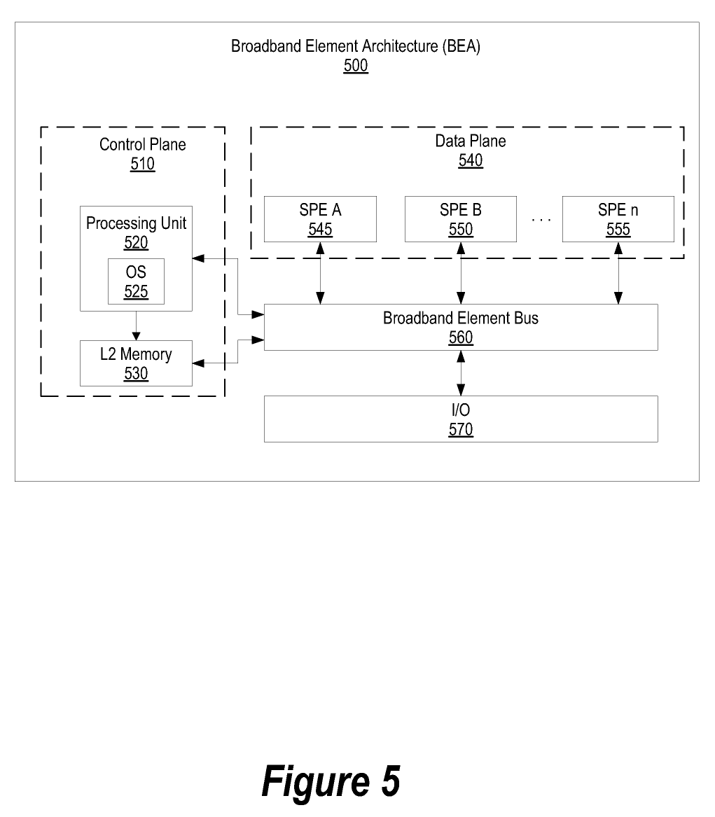

FIG. 5 is a diagram showing a broadband element architecture which includes a plurality of heterogeneous processors capable of implementing the invention described herein. The heterogeneous processors share a common memory and a common bus. Broadband element architecture (BEA) 500 sends and receives information to/from external devices through input output 570, and distributes the information to control plane 510 and data plane 540 using processor element bus 560. Control plane 510 manages BEA 500 and distributes work to data plane 540.

Control plane 510 includes processing unit 520 which runs operating system (OS) 525. For example, processing unit 520 may be a Power PC core that is embedded in BEA 500 and OS 525 may be a Linux operating system. Processing unit 520 manages a common memory map table for BEA 500. The memory map table corresponds to memory locations included in BEA 500, such as L2 memory 530 as well as non-private memory included in data plane 540.

Data plane 540 includes Synergistic processing element's (SPE) 545, 550, and 555. Each SPE is used to process data information and each SPE may have different instruction sets. For example, BEA 500 may be used in a wireless communications system and each SPE may be responsible for separate processing tasks, such as modulation, chip rate processing, encoding, and network interfacing. In another example, each SPE may have identical instruction sets and may be used in parallel to perform operations benefiting from parallel processes.

Each SPE includes a synergistic processing unit (SPU) which is a processing core, such as a digital signal processor, a microcontroller, a microprocessor, or a combination of these cores.

SPE 545, 550, and 555 are connected to processor element bus 560, which passes information between control plane 510, data plane 540, and input/output 570. Bus 560 is an on-chip coherent multi-processor bus that passes information between I/O 570, control plane 510, and data plane 540. Input/output 570 includes flexible input-output logic which dynamically assigns interface pins to input output controllers based upon peripheral devices that are connected to BEA 500.

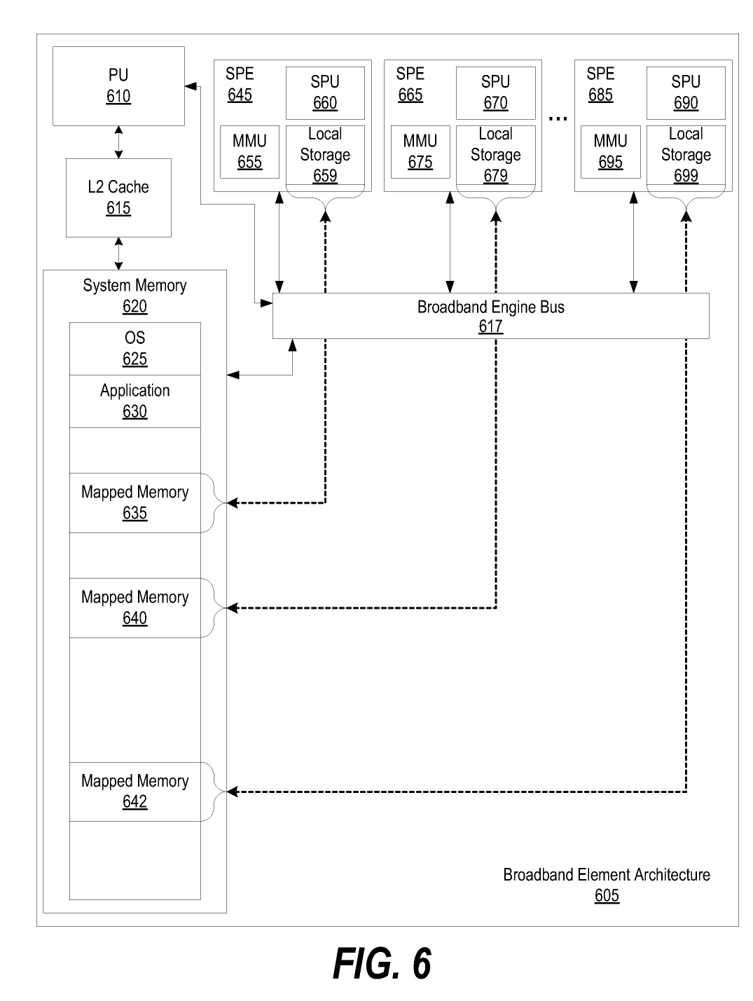

FIG. 6 is a block diagram illustrating a processing element having a main processor and a plurality of secondary processors sharing a system memory. Broadband Element Architecture (BEA) 605 includes processing unit (PU) 610, which, in one embodiment, acts as the main processor and runs the operating system. Processing unit 610 may be, for example, a Power PC core executing a Linux operating system. BEA 605 also includes a plurality of synergistic processing elements (SPEs) such as SPEs 645 through 685. Each SPE includes a synergistic processing unit (SPU) that act as secondary processing units to PU 610, a memory storage unit, and local storage. For example, SPE 645 includes SPU 660, MMU 655, and local storage 659; SPE 665 includes SPU 670, MMU 675, and local storage 679; and SPE 685 includes SPU 690, MMU 695, and local storage 699.

In one embodiment, the SPEs process data under the control of PU 610. The SPEs may be, for example, digital signal processing cores, microprocessor cores, micro controller cores, etc., or a combination of the above cores. In one embodiment, each one of the local stores is a storage area associated with a particular SPU. Each SPU can configure its local store as a private storage area, a shared storage area, or an SPU's local store may be partly private and partly shared.

For example, if an SPU requires a substantial amount of local memory, the SPU may allocate 100% of its local store to private memory accessible only by that SPU. If, on the other hand, an SPU requires a minimal amount of local memory, the SPU may allocate 10% of its local store to private memory and the remaining 90% to shared memory. The shared memory is accessible by PU 610 and by the other SPEs. An SPU may reserve part of its local store in order for the SPU to have fast, guaranteed access to some memory when performing tasks that require such fast access. The SPU may also reserve some of its local store as private when processing sensitive data, as is the case, for example, when the SPU is performing encryption/decryption.

The MMUs are responsible for transferring data between an SPU's local store and the system memory. In one embodiment, an MMU includes a direct memory access (DMA) controller configured to perform this function.

Each SPE may be set up to perform a different task, and accordingly, in one embodiment, each SPE may be accessed using different instruction sets. If BEA 605 is being used in a wireless communications system, for example, each SPE may be responsible for separate processing tasks, such as modulation, chip rate processing, encoding, network interfacing, etc. In another embodiment, each SPE may have identical instruction sets and may be used in parallel to perform operations benefiting from parallel processes.

The shared portion of the SPEs' local stores may be accessed by PU 610 as well as by the other SPEs by mapping each shared region to system memory 620. In one embodiment, PU 610 manages the memory map for the common system memory 620. The memory map table may include PU 610's L2 Cache 615, system memory 620, as well as the SPEs' shared local stores.

A portion of system memory 620 as shown is occupied by the operating system (OS 625). System Memory 625 also contains data 640, which represents data to be processed by SPU 610 as well as by the SPEs. In one embodiment, a process executing on the PU receives a request for a task involving the processing of large data. The PU first determines an optimum method for performing the task as well as an optimum placement of the data in common system memory 620. The PU may then initiate a transfer of the data to be processed from disk 635 to system memory 620. In one embodiment, the PU arranges the data in system memory 625 in data blocks the size of the registers of the SPEs. In one embodiment, the SPEs may have 128 registers, each register being 128 bits long.

The PU then searches for available SPEs and assigns blocks of data to any available SPEs for processing of the data. The SPEs can access the common system memory (through a DMA command, for example) transfer the data to the SPEs' local store, and perform the assigned operations. After processing the data, the SPEs may transfer the data (using DMA again, for example) back to common system memory 620. This procedure may be repeated as SPEs become available until all the data blocks have been processed.

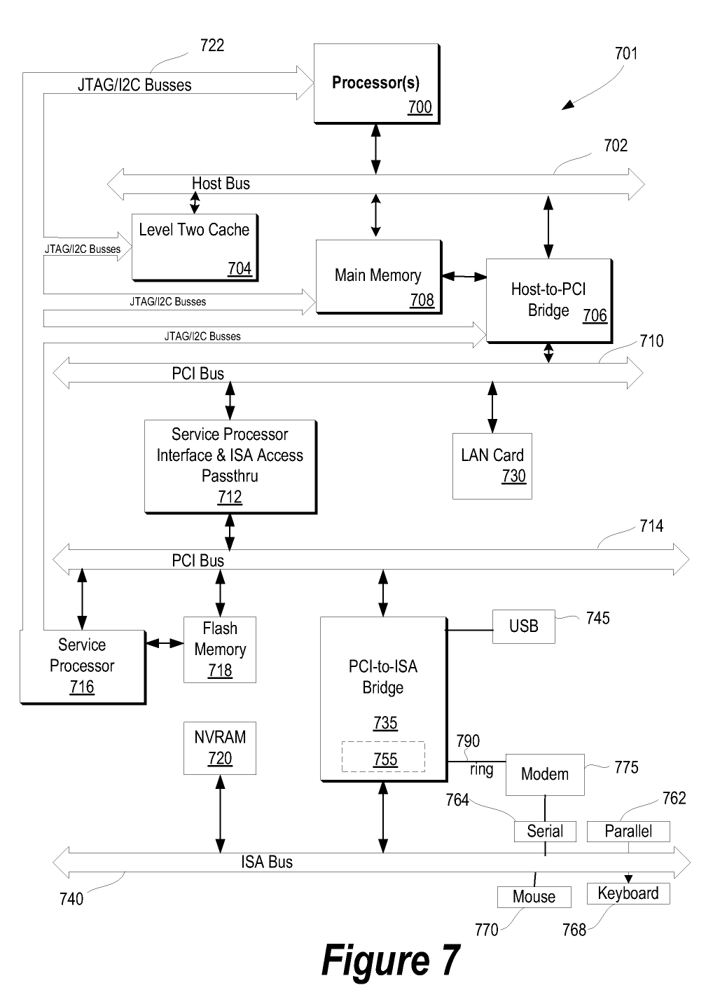

FIG. 7 illustrates information handling system 701 which is a simplified example of a computer system capable of performing the computing operations described herein. Computer system 701 includes processor 700 which is coupled to host bus 702. A level two (L2) cache memory 704 is also coupled to host bus 702. Host-to-PCI bridge 706 is coupled to main memory 708, includes cache memory and main memory control functions, and provides bus control to handle transfers among PCI bus 710, processor 700, L2 cache 704, main memory 708, and host bus 702. Main memory 708 is coupled to Host-to-PCI bridge 706 as well as host bus 702. Devices used solely by host processor(s) 700, such as LAN card 730, are coupled to PCI bus 710. Service Processor Interface and ISA Access Pass-through 712 provides an interface between PCI bus 710 and PCI bus 714. In this manner, PCI bus 714 is insulated from PCI bus 710. Devices, such as flash memory 718, are coupled to PCI bus 714. In one implementation, flash memory 718 includes BIOS code that incorporates the necessary processor executable code for a variety of low-level system functions and system boot functions.

PCI bus 714 provides an interface for a variety of devices that are shared by host processor(s) 700 and Service Processor 716 including, for example, flash memory 718. PCI-to-ISA bridge 735 provides bus control to handle transfers between PCI bus 714 and ISA bus 740, universal serial bus (USB) functionality 745, power management functionality 755, and can include other functional elements not shown, such as a real-time clock (RTC), DMA control, interrupt support, and system management bus support. Nonvolatile RAM 720 is attached to ISA Bus 740. Service Processor 716 includes JTAG and I2C busses 722 for communication with processor(s) 700 during initialization steps. JTAG/I2C busses 722 are also coupled to L2 cache 704, Host-to-PCI bridge 706, and main memory 708 providing a communications path between the processor, the Service Processor, the L2 cache, the Host-to-PCI bridge, and the main memory. Service Processor 716 also has access to system power resources for powering down information handling device 701.

Peripheral devices and input/output (I/O) devices can be attached to various interfaces (e.g., parallel interface 762, serial interface 764, keyboard interface 768, and mouse interface 770 coupled to ISA bus 740. Alternatively, many I/O devices can be accommodated by a super I/O controller (not shown) attached to ISA bus 740.

In order to attach computer system 701 to another computer system to copy files over a network, LAN card 730 is coupled to PCI bus 710. Similarly, to connect computer system 701 to an ISP to connect to the Internet using a telephone line connection, modem 775 is connected to serial port 764 and PCI-to-ISA Bridge 735.

While FIG. 7 shows one information handling system that employs processor(s) 700, the information handling system may take many forms. For example, information handling system 701 may take the form of a desktop, server, portable, laptop, notebook, or other form factor computer or data processing system. Information handling system 701 may also take other form factors such as a personal digital assistant (PDA), a gaming device, ATM machine, a portable telephone device, a communication device or other devices that include a processor and memory.

One of the preferred implementations of the invention is a client application, namely, a set of instructions (program code) in a code module that may, for example, be resident in the random access memory of the computer. Until required by the computer, the set of instructions may be stored in another computer memory, for example, in a hard disk drive, or in a removable memory such as an optical disk (for eventual use in a CD ROM) or floppy disk (for eventual use in a floppy disk drive). Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A computer-implemented method comprising:
executing a test case that includes an intentional interrupt instruction, wherein the intentional interrupt instruction is constructed to intentionally generate an interrupt;
in response to executing the intentional interrupt instruction, generating an intentional interrupt;
processing the intentional interrupt by incrementing an instruction address register, which is selected from the group consisting of an instruction address register and a link register, to an instruction address subsequent to the executed intentional interrupt instruction; and
continuing the execution of the test case at the subsequent instruction address.

2. The method of claim 1 wherein the intentional interrupt is an instruction storage interrupt, the method further comprising:
during the building of the test case, including a branch instruction in the test case as the intentional interrupt instruction, and excluding a corresponding instruction address translation from the test case;
in response to processing the instruction storage interrupt, determining that the instruction address translation is not included in a translation lookaside buffer; and
generating the instruction storage interrupt in response to determining that the instruction address translation is not included in the translation lookaside buffer.

3. The method of claim 2 further comprising:
in response to determining that the instruction address translation is not included in a translation lookaside buffer, checking whether the instruction address translation is included in a page table;
in response to determining that the instruction address translation is not included in the page table, generating the instruction storage interrupt.

4. The method of claim 1 wherein the intentional interrupt is a data storage interrupt, the method further comprising:
during the building of the test case, including a load/store instruction as the intentional interrupt instruction and excluding a corresponding data address translation from the test case;
in response to processing the data storage interrupt, determining that the data address translation is not included in a translation lookaside buffer; and
generating the data storage interrupt in response to determining that the data address translation is not included in the translation lookaside buffer.

5. The method of claim 4 further comprising:
in response to determining that the data address translation is not included in a translation lookaside buffer, checking whether the data address translation is included in a page table; and
in response to determining that the data address translation is not included in the page table, generating the data storage interrupt.

6. The method of claim 1 wherein the intentional interrupt is an alignment interrupt, the method further comprising:
during the building of the test case, including an instruction in the test case as the intentional interrupt instruction that corresponds to an unaligned effective address;
in response to processing the instruction, detecting the unaligned effective address; and
generating the alignment interrupt in response to detecting the unaligned effective address.

7. The method of claim 1 wherein the intentional interrupt is a program interrupt, the method further comprising:
during the building of the test case, including an illegal instruction in the test case as the intentional interrupt instruction;
in response to processing the illegal instruction, determining whether the execution is at the end of the test case; and
in response to determining that the execution is not at the end of the test case, performing the incrementing of the instruction address register.

8. The method of claim 1 wherein the method is performed in conjunction with an instruction shuffling process.

9. An information handling system comprising:
one or more processors;
a memory accessible by the processors;
one or more nonvolatile storage devices accessible by the processors; and
a set of instructions stored in the memory, wherein one or more of the processors executes the set of instructions in order to perform actions of:
executing a test case that includes an intentional interrupt instruction, wherein the intentional interrupt instruction is constructed to intentionally generate an interrupt;
in response to executing the intentional interrupt instruction, generating an intentional interrupt;
processing the intentional interrupt by incrementing a register, which is selected from the group consisting of an instruction address register and a link register, to an instruction address subsequent to the executed intentional interrupt instruction; and
continuing the execution of the test case at the subsequent instruction address.

10. The information handling system of claim 9 wherein the intentional interrupt is an instruction storage interrupt, the information handling system further comprising an additional set of instructions in order to perform actions of:
during the building of the test case, including a branch instruction in the test case as the intentional interrupt instruction, and excluding a corresponding instruction address translation from the test case;
in response to processing the instruction storage interrupt, determining that the instruction address translation is not included in a translation lookaside buffer; and
generating the instruction storage interrupt in response to determining that the instruction address translation is not included in the translation lookaside buffer.

11. The information handling system of claim 10 further comprising an additional set of instructions in order to perform actions of:
in response to determining that the instruction address translation is not included in a translation lookaside buffer, checking whether the instruction address translation is included in a page table;
in response to determining that the instruction address translation is not included in the page table, generating the instruction storage interrupt.

12. The information handling system of claim 9 wherein the intentional interrupt is a data storage interrupt, the information handling system further comprising an additional set of instructions in order to perform actions of:
during the building of the test case, including a load/store instruction as the intentional interrupt instruction and excluding a corresponding data address translation from the test case;
in response to processing the data storage interrupt, determining that the data address translation is not included in a translation lookaside buffer; and
generating the data storage interrupt in response to determining that the data address translation is not included in the translation lookaside buffer.

13. The information handling system of claim 9 wherein the intentional interrupt is an alignment interrupt, the information handling system further comprising an additional set of instructions in order to perform actions of:
during the building of the test case, including an instruction in the test case as the intentional interrupt instruction that corresponds to an unaligned effective address;
in response to processing the instruction, detecting the unaligned effective address; and
generating the alignment interrupt in response to detecting the unaligned effective address.

14. The information handling system of claim 9 wherein the intentional interrupt is a program interrupt, the information handling system further comprising an additional set of instructions in order to perform actions of:
during the building of the test case, including an illegal instruction in the test case as the intentional interrupt instruction;
in response to processing the illegal instruction, determining whether the execution is at the end of the test case; and
in response to determining that the execution is not at the end of the test case, performing the incrementing of the instruction address register.

15. A computer program product stored on a computer operable media, the computer operable media containing instructions for execution by a computer, which, when executed by the computer, cause the computer to implement a method of processing test patterns, the method comprising:
executing a test case that includes an intentional interrupt instruction, wherein the intentional interrupt instruction is constructed to intentionally generate an interrupt;
in response to executing the intentional interrupt instruction, generating an intentional interrupt;
processing the intentional interrupt by incrementing a register, which is selected from the group consisting of an instruction address register and a link register, to an instruction address subsequent to the executed intentional interrupt instruction; and
continuing the execution of the test case at the subsequent instruction address.

16. The computer program product of claim 15 wherein the intentional interrupt is an instruction storage interrupt, the method further comprising:
during the building of the test case, including a branch instruction in the test case as the intentional interrupt instruction, and excluding a corresponding instruction address translation from the test case;
in response to processing the instruction storage interrupt, determining that the instruction address translation is not included in a translation lookaside buffer; and
generating the instruction storage interrupt in response to determining that the instruction address translation is not included in the translation lookaside buffer.

17. The computer program product of claim 16 wherein the method further comprises:
in response to determining that the instruction address translation is not included in a translation lookaside buffer, checking whether the instruction address translation is included in a page table;
in response to determining that the instruction address translation is not included in the page table, generating the instruction storage interrupt.

18. The computer program product of claim 15 wherein the intentional interrupt is a data storage interrupt, the method further comprising:
during the building of the test case, including a load/store instruction as the intentional interrupt instruction and excluding a corresponding data address translation from the test case;
in response to processing the data storage interrupt, determining that the data address translation is not included in a translation lookaside buffer; and
generating the data storage interrupt in response to determining that the data address translation is not included in the translation lookaside buffer.

19. The computer program product of claim 15 wherein the intentional interrupt is an alignment interrupt, the method further comprising:
during the building of the test case, including an instruction in the test case as the intentional interrupt instruction that corresponds to an unaligned effective address;
in response to processing the instruction, detecting the unaligned effective address; and
generating the alignment interrupt in response to detecting the unaligned effective address.

20. The computer program product of claim 15 wherein the intentional interrupt is a program interrupt, the method further comprising:
during the building of the test case, including an illegal instruction in the test case as the intentional interrupt instruction;
in response to processing the illegal instruction, determining whether the execution is at the end of the test case; and
in response to determining that the execution is not at the end of the test case, performing the incrementing of the instruction address register.
